(19) United States
(12) Patent Application Publication
(10) Pub. No.: US 2011/0297416 A1
(43) Pub. Date: Dec. 8, 2011

(54) CONNECTING MEMBER

(75) Inventors: CHUNG-CHENG HSIEH, Tu-Cheng (TW); LI-PING CHEN, Tu-Cheng (TW)

(73) Assignee: HON HAI PRECISION INDUSTRY CO., LTD., Tu-Cheng (TW)

(21) Appl. No.: 12/884,697

(22) Filed: Sep. 17, 2010

(30) Foreign Application Priority Data
Jun. 8, 2010 (CN) 201010195062.4

(51) Int. Cl. H01B 7/06

(52) U.S. Cl. 174/69

(57) ABSTRACT

A connecting member includes an elastic element and a cable assembly. The cable assembly includes a flexible cable. The flexible cable is attached to the elastic element along an extension direction of the elastic element. The elastic element is elastically deformable between an original state and an extended state. In the original state, the elastic element and the cable are in a spiral. In the extended state, the elastic element and the flexible cable are extended within a plane.

### CROSS-REFERENCE TO RELATED APPLICATION

This application is related to co-pending U.S. patent application entitled “CONNECTING MEMBER”, application Ser. No. 12/882,602, Application date Sep. 15, 2010, Attorney Docket number US33076.

### BACKGROUND

1. Technical Field

The present disclosure relates to a connecting member for connecting two electronic components of an electronic device.

2. Description of Related Art

Generally, a cable is configured for connecting electronic components, such as a hard disk, a motherboard, or an optical disk drive. The cable normally has a surplus portion when connected to the electronic components in order to assure the different distances between each component can be accommodated. The surplus portion of the cable takes up a lot of space between the electronic components and is usually disorderly placed in the electronic device.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of a connecting member in accordance with an embodiment.

FIG. 2 is a front assembled view of FIG. 1, showing the connecting member in an original state.

FIG. 3 is similar to FIG. 2, but partially showing the connecting member in an extended state.

FIG. 4 is an assembled view of a connecting member in accordance with another embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

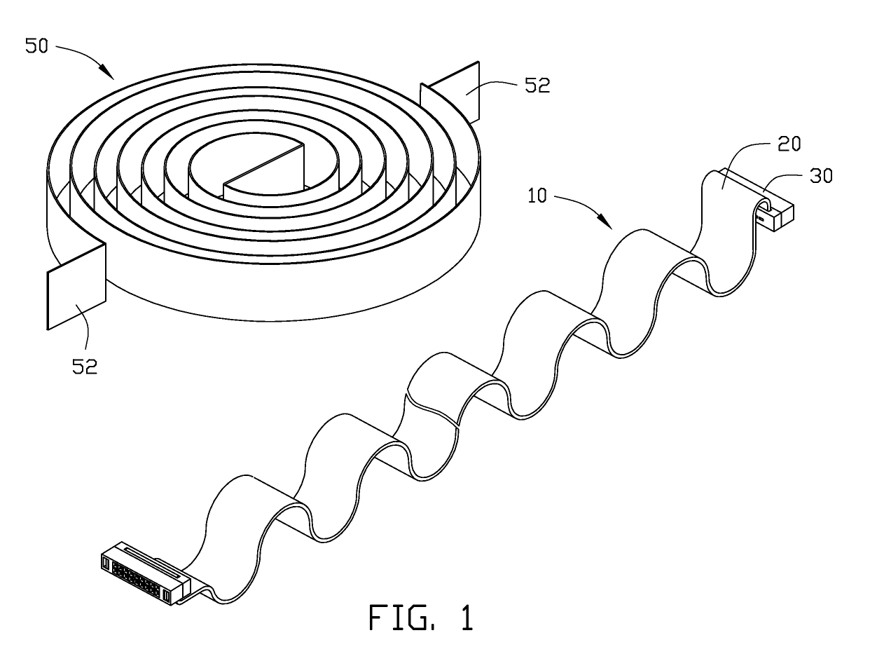

Referring to FIG. 1, a connecting member in accordance with an embodiment includes a cable assembly 10 and an elastic element 50.

The cable assembly 10 includes a flexible cable 20, and two connectors 30. The cable assembly 10 is configured to connect two electronic components (not shown) of an electronic device (not shown) and transfer electrical or data signal between the two electronic components. In one embodiment, the electronic device can be a computer, or a server. The electronic components can be a storage device, or a motherboard. The cable 20 is strip shaped.

The two connectors 30 are located at opposite distal ends of the cable 20 and configured to connect two corresponding connectors (not shown) of the electronic components.

In one embodiment, the elastic element 50 is a substantially dual torsion extendable coil spring. The elastic element 50 includes two end portions 52. The elastic element 50 is elastically deformable between an original state and an extended state. In the original state, the elastic element 50 is constricted as a spiral in a plane. In the extended state, the two end portions 52 of elastic element 50 extend towards opposite directions within the plane. In one embodiment, a length of the elastic element 50 is equal or smaller than that of the cable assembly 10, and the width of the elastic element 50 is equal or greater than that of the cable 20.

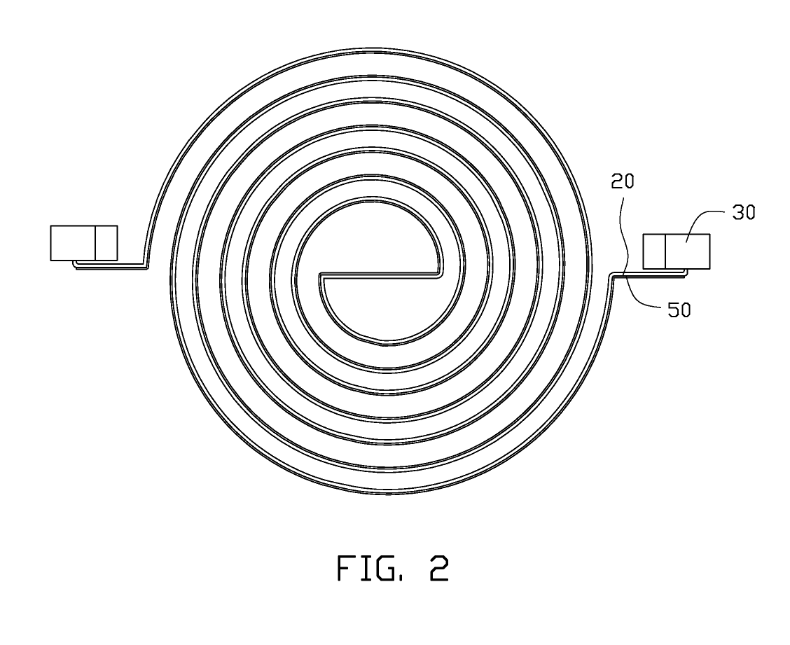

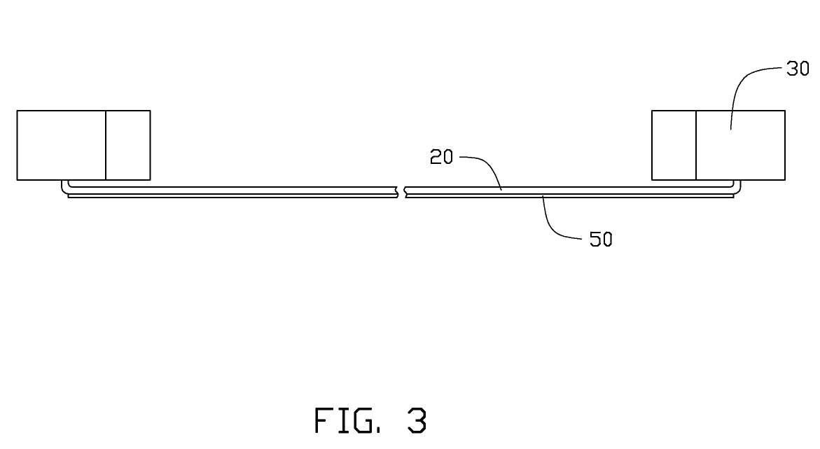

Referring to FIG. 2 and FIG. 3, during assembly of the connecting member, the cable assembly 10 is mounted to a surface of elastic element 50. The cable assembly 10 may be mounted to the elastic element 50 by adhesives, screws, or rivets. The two connectors 30 of the cable assembly 10 are located on the two end portions 52 of the elastic element 50. When the elastic element 50 is in the original state, the cable 20 is constricted to spiral with the elastic element 50. In the original state, the cable 20 is curled and occupies less space.

In use, two electronic components may be placed in different positions. In order to connect the two electronic components with the cable assembly 10, the cable assembly 10 is stretched with an elastically stretching of the elastic element 50 to couple to the two electronic components. When the cable assembly 10 is disassembled, the cable assembly 10 is disengaged from the two electronic components, the elastic element 50 is released to drive the cable 20 to constrict to the original state. In this way, the cable assembly 10 is capable of being placed orderly between the electronic components.

In addition, the cable 20 is capable of stretching and constricting with the elastic element 50 that is mounted to the cable 20, therefore, the cable 20 is not easily damaged when the connectors 30 are connected to the electronic components. The cable 20 is placed orderly between the electronic components in an enclosure (not shown), and will not influence heat dissipation in the enclosure.

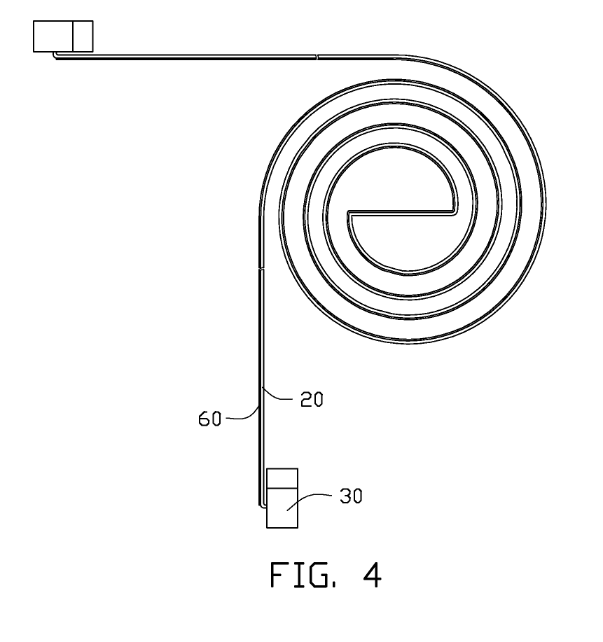

Referring to FIG. 4, in another embodiment, an elastic element 60 is shown. The elastic element 60 includes two distal end portions extending towards angled directions. Thus, the cable assembly 10 mounted to the elastic element 60 can connect two electronic components, which are placed at an angle with respect to each other, more flexibly.

In another embodiment, the elastic element 60 may have a shrink strip. The shrink strip is made of polyvinyl chloride (PVC) for adhesion to the cable 20. Thus, the cable 20 received in the shrink strip may be heat insulated from the elastic element 60.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A connecting member comprising:
an elastic element; and
a cable assembly, the cable assembly comprising a flexible cable, the flexible cable being attached to the elastic element along an extension direction of the elastic element;
wherein the elastic element is elastically deformable between an original state, where the elastic element and the flexible cable are in a spiral, and an extended state, where the elastic element and the flexible cable are extended.

2. The connecting member of claim 1, wherein the cable assembly further comprises two connectors located on opposite ends of the flexible cable for connecting two electronic components, and the two connectors are located on two opposite end portions of the elastic element.

3. The connecting member of claim 1, wherein the flexible cable is mounted to the elastic element by adhesives.

4. The connecting member of claim 1, wherein the flexible cable is strip shaped.

5. The connecting member of claim 1, wherein the elastic element has a shrink strip, and the shrink strip is made of polyvinyl chloride for adhering the flexible cable.

6. The connecting member of claim 1, wherein a width of the elastic element is equal or greater than that of the flexible cable.

7. The connecting member of claim 1, wherein a length of the elastic element is equal or smaller than that of the cable assembly.

8. The connecting member of claim 1, wherein the elastic element comprises a dual torsion extendable coil spring.

9. The connecting member of claim 1, wherein the elastic element comprises a first end portion and a second end portion, in the original state, the first end portion extends towards a first direction and the second end portion extends towards a second direction, and the first direction is opposite to the second direction.

10. The connecting member of claim 1, wherein the elastic element comprises a first end portion and a second end portion, when in the original state, the first end portion extends toward a first direction, and the second end portion extends toward a second direction, the first direction is at an angle with respect to the second direction.

11. A connecting member comprising:
an elastic element; and
a cable assembly, the cable assembly comprising a flexible cable, and the flexible cable being attached to the elastic element along an extension direction of the elastic element;
wherein the elastic element is elastically deformable between an original state, where the elastic element and the flexible cable are in a spiral, and an extended state, where the elastic element and the flexible cable are extended.

12. The connecting member of claim 11, wherein the cable assembly further comprises a two connectors located on opposite ends of the flexible cable for connecting two electronic components, and the two connectors are located on two opposite end portions of the elastic element.

13. The connecting member of claim 11, wherein the flexible cable is mounted to the elastic element by adhesives.

14. The connecting member of claim 11, wherein the flexible cable is strip shaped.

15. The connecting member of claim 11, wherein the elastic element has a shrink strip, and the shrink strip is made of polyvinyl chloride for adhering the flexible cable.

16. The connecting member of claim 11, wherein a width of the elastic element is equal or greater than that of the flexible cable.

17. The connecting member of claim 11, wherein a length of the elastic element is equal or smaller than that of the cable assembly.

18. The connecting member of claim 11, wherein the elastic element is a substantially dual torsion extendable coil spring.

19. The connecting member of claim 11, wherein the elastic element comprises a first end portion and a second end portion; when in the original state, the first end portion extends towards a first direction and the second end portion extends towards a second direction, and the first direction is opposite to the second direction.

20. The connecting member of claim 11, wherein the elastic element comprises a first end portion and a second end portion, in the original state, the first end portion extends towards a first direction, and the second end portion extends towards a second direction, the first direction is at an angle with respect to the second direction.
